(19) United States
(12) Patent Application Publication
(10) Pub. No.: US 2021/0230913 A1
(43) Pub. Date: Jul. 29, 2021

(54) COMPARTMENT LOCKING SYSTEM

(71) Applicant: Tiffin Metal Products Co., Tiffin, OH (US)

(72) Inventors: Kyle Christopher Dukeshire, Fremont, OH (US); Isaac Charles Innis, Tiffin, OH (US)

(21) Appl. No.: 16/773,169

(22) Filed: Jan. 27, 2020

(51) Int. Cl. E05C 5/02; E05C 19/12; E05B 65/44

(52) U.S. Cl. CPC E05C 5/02; E05C 19/12; E05Y 2900/602; E05Y 2201/47; E05B 65/44

(57) ABSTRACT

A locking system and method for using the locking system for a compartment are provided. The system may have a plunger, at least one leg pivotally attached to plunger and a first biasing member connecting the plunger with the at least one leg.

### FIELD

A locking system for a compartment is described. The compartment may have a first locker and a second locker where the second locker may be selectively locked with the locking system.

### BACKGROUND

Locker units may comprise upper and lower lockers. Often, the upper locker may be selectively accessed via a door. The lower locker may be accessed via a drawer.

Some prior art units secure the upper and lower lockers with two separate locks. Depending on the types of separate locks, these prior art units have a number of disadvantages including increased cost for the manufacture and end consumer, additional parts, additional keys or combinations to keep track of, and additional failure modes, to name a few.

Other prior art units couple a locking mechanism between the upper and lower lockers. These prior art units, however, are also disadvantageous because they do not permit an open lower locker to be closed when the upper locker is already closed. It would be advantageous to have a lower locker that can be moved from an open position to a closed position when the upper locker is closed.

### SUMMARY

In one embodiment, a locking system for a compartment and method of use is described. The system may be provided a plunger. The plunger may have an upper portion, a central portion and a lower portion. At least one leg may be pivotally attached to the plunger, such as the lower portion. A first biasing member may also be provided. The first biasing member may connect the plunger with the at least one leg.

In another aspect the plunger may have a first side, a second side, a third side and a fourth side where the first and second sides may be parallel one another and the third and fourth sides may be parallel one another.

In another aspect the upper portion of the plunger may have a finger extending laterally from the third side.

In another aspect a second biasing member may be coiled about the upper portion of the plunger.

In another aspect a lower portion of the plunger may have at least one slotted arc cam way.

In another aspect a stop may extend laterally from the third side of the plunger where the stop separates the central portion from the lower portion.

In another aspect the first biasing member may be connected adjacent the fourth side of the plunger.

In another aspect the plunger may be non-symmetrical about a longitudinal axis.

In another aspect the at least one leg may have at least one cam follower, where the cam follower is located within the slotted arc cam way.

In another aspect the at least one leg may have an arm laterally offset from the longitudinal axis of the plunger.

In another aspect the at least one leg may have an upper flange located laterally offset from the at least one cam follower where upper flange may be connected to the first biasing member.

In another aspect the at least one leg may comprise a first leg and a second leg where the lower portion of the plunger may be located between the first leg and the second leg.

In another aspect the first and second legs may have complementary shaped and aligned lower flanges.

In another aspect, a locking flange may have an anchor portion and a trip portion, where the trip portion may be located at an angle with respect to the anchor portion, where the at least one leg pivots past the trip portion when a first side of the at least one leg contacts a first side of the trip portion or the at least one leg locks with a second side of the trip portion when a second side of the at least one leg contacts the second side of the trip portion.

In another aspect a method for using a locking system for a compartment may comprise providing a longitudinally movable plunger; pivotally attaching at least one leg to the plunger; and providing a first biasing member connecting the plunger with the at least one leg.

In another aspect the plunger may be selectively biased in a longitudinally raised position with a second biasing member longitudinally aligned with the plunger, where both the plunger and the at least one leg may longitudinally raise together.

In another aspect the plunger may be selectively located in a longitudinally lowered position with a movable member depressing the plunger against the second biasing member, wherein both the plunger and the at least one leg longitudinally lower together.

In another aspect the plunger and at least one leg may be longitudinally raised, providing a longitudinal gap between the at least one leg and a locking flange so that the two do not come in contact in the longitudinal raised position.

In another aspect in the lowered position the at least one leg and a locking flange are at least partially longitudinally aligned.

In another aspect in the lowered position, in a first direction, the at least one leg pivots past a trip portion of the locking flange when a first side of the at least one leg contacts a first side of the trip portion, and in a second, opposite direction to the first direction, the at least one leg locks with a second side of the trip portion when a second side of the at least one leg contacts the second side of the trip portion.

### BRIEF DESCRIPTION OF THE DRAWINGS

The above, as well as other advantages of the device, will become readily apparent to those skilled in the art from the following detailed description when considered in the light of the accompanying drawings in which:

FIG. 1 depicts one embodiment of a perspective view of a compartment;

FIG. 2 depicts a detail from FIG. 1;

FIG. 3 depicts a perspective view of one embodiment of a component from FIG. 1;

FIG. 4 depicts a perspective view of one embodiment of components in one condition;

FIG. 5 depicts a perspective view of one embodiment of components in another condition;

FIG. 6 depicts a perspective view of one embodiment of components in another condition;

FIG. 7 depicts a perspective view of one embodiment of components in another condition;

FIG. 8 depicts another perspective view of one embodiment of components;

FIG. 9 depicts a side view of one embodiment of components;

FIG. 10 depicts a top view of one embodiment of components;

FIG. 11 depicts an end view of one embodiment of components; and

FIG. 12 depicts a perspective view of another embodiment.

### DETAILED DESCRIPTION OF THE PREFERRED EMBODIMENTS

It is to be understood that the device may assume various alternative orientations and step sequences, except where expressly specified to the contrary. It is also to be understood that the specific devices and processes illustrated in the attached drawings, and described in the following specification are simply exemplary embodiments of the concepts defined in the appended claims. Hence, specific dimensions, directions or other physical characteristics relating to the embodiments disclosed are not to be considered as limiting, unless the claims expressly state otherwise.

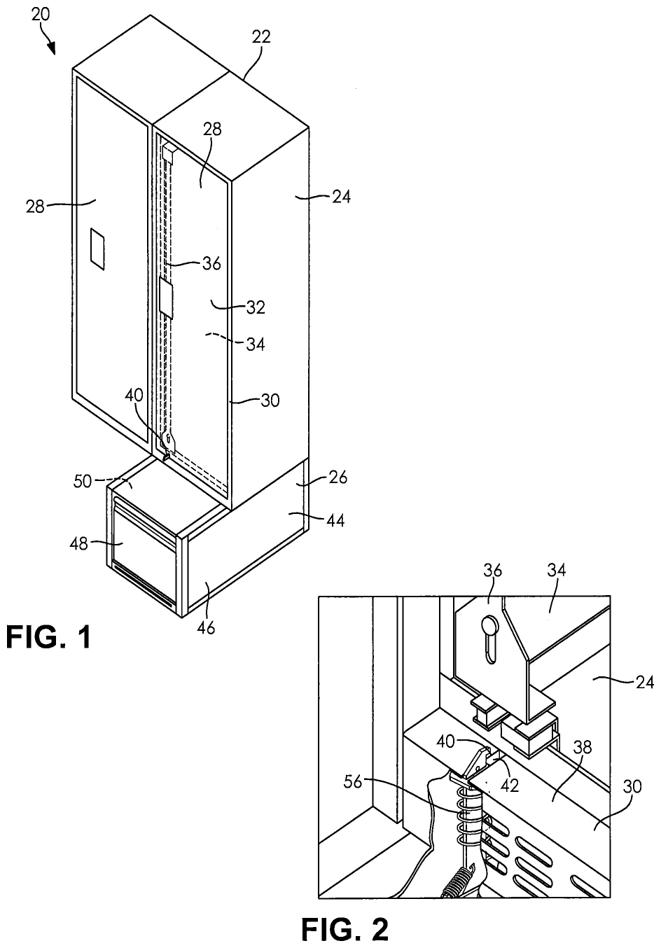

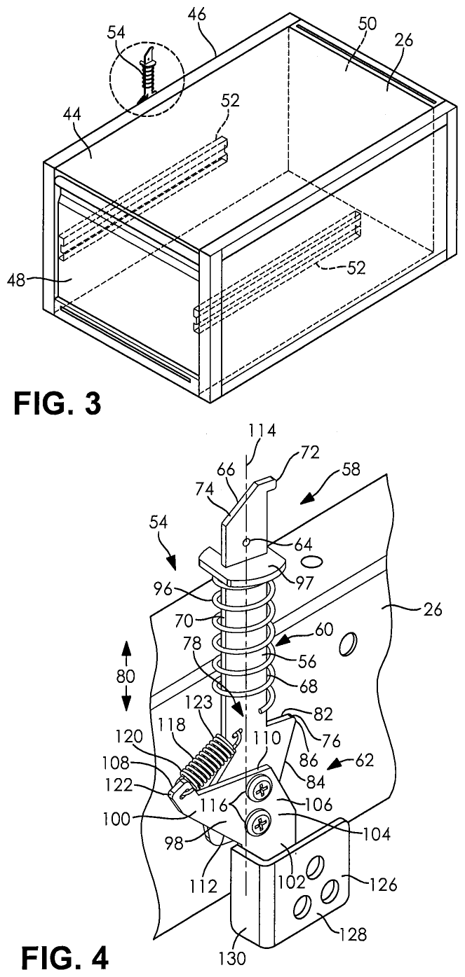

Turning now to FIG. 1, one embodiment of a compartment 20 is schematically depicted. While a compartment 20 of one shape and size is depicted in FIG. 1, its structures and method of using it described herein is not limited to this compartment 20.

The compartment 20 may be such a locker system 22. While a locker system 22 is used to illustrate the utility and operation of the device and its method, the compartment 20 may be used with other structures, including, but not limited to, cabinets, furniture, and/or desks.

The locker system 22 may be comprised of one or more lockers connected together (as schematically depicted) or it may be a single, stand-alone system. Regardless of the number of lockers, the locker system may have first and second lockers 24, 26.

In the embodiment depicted in FIG. 1, the locker system 22 may have a first locker 24 located above a second locker 26. While the first locker 24 is located above the second locker 26 in this embodiment, the two lockers 24, 26 may be located diagonal from one another or in other orientations, preferably as long as there is some vertical and horizontal overlap between them.

The depicted embodiment shows the second locker 26 being deeper compared with the first locker 24; this is not a requirement for the device and method described herein. Instead, the first and second lockers 24, 26 may be of equal or unequal dimensions.

In FIG. 1, the first locker 24 may be provided with a first movable member. The first movable member may be such as a movable door 28 secured to a stationary frame 30 of the first locker 24. The door 28 may be mounted to the frame 30 such as by hinges (not shown) or other structure that permit relative movement of the door 28 with respect to the frame 30. When the door 28 is positioned within the frame 30, the door 28 blocks an opening 32 in the first locker 24 that provides access to an interior 34 of the first locker 24. When the door 28 is moved out of the frame 30, access to the first locker interior 34 is provided.

The door 28 may be selectively secured, such as locked, to the frame 30. In one embodiment, the door 28 may be locked to the frame 30 by a movable linkage 36. The linkage 36 may extend the length of the door 28, or only a portion of the door 28. The linkage 36 may selectively engage the frame 30 to secure the door 28 to the frame 30. The linkage 36 may have a lock or a separate lock (e.g., a padlock or combination lock) which may be secured through the linkage 36 and a structure associated with the door 28.

The frame 30 may have a lower portion 38. In the depicted embodiment, the lower portion 38 may have a slot 40 located therein, as shown in FIG. 2. The slot 40 can be any shape or size, but in this embodiment, the slot 40 may be oval or rectangular shaped. The slot 40 extends entirely through the lower portion 38 of the frame 30 to define an opening 42.

As noted above, the second locker 26 may be located below the first locker 24. In the depicted embodiment, the second locker 26 may be comprised of a drawer system 44. The drawer system 44 may have a stationary housing 46 and a drawer 48 that may be selectively located in and out, to any proportion or degree, of the housing 46. Preferably, the drawer 48 may be substantially located within the housing 46 when it is in a closed orientation. In an open orientation, the drawer 48 provides access to an interior 50 of the drawer 48.

The drawer system 44 may also be comprised of slides or glides 52. The slides/glides 52 comprise one portion that is attached to the drawer 48 and one portion that is attached to the stationary housing 46. The two portions may have ball bearings, or other friction reducing devices, between them that facilitate at least one of the two portions moving with respect to one another. The slides/glides 52 facilitate selectively locating the drawer 48 in and out of the housing 46.

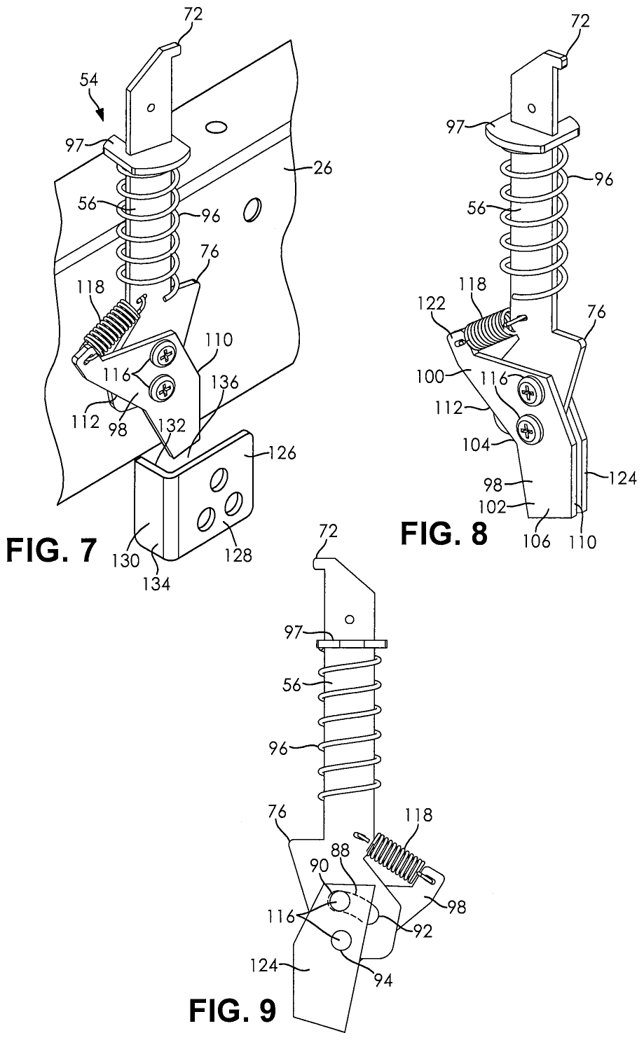

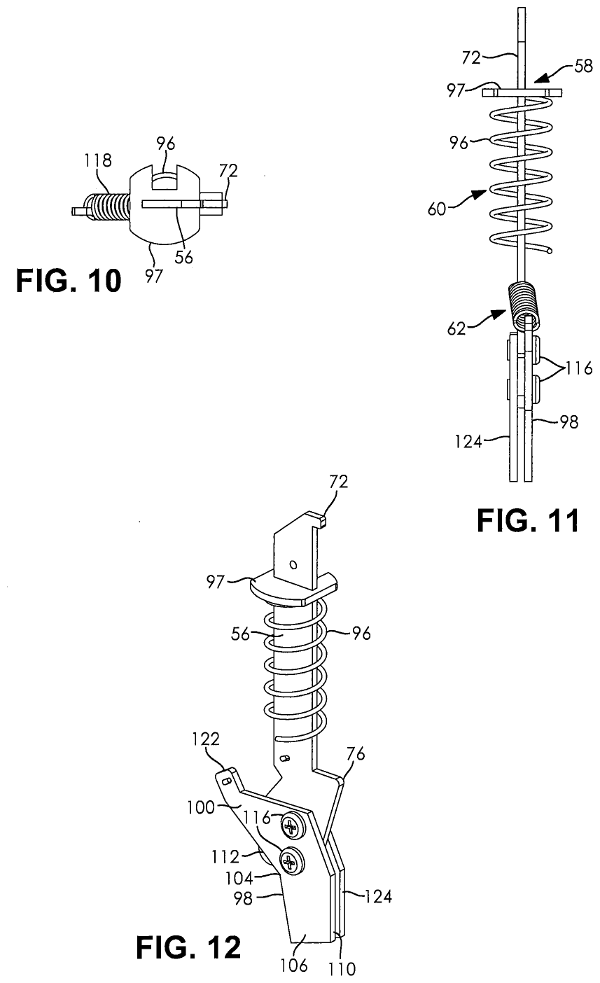

With reference now to at least FIGS. 4-11, a locking system 54 for the compartment 20 will be discussed. The locking system 54 may have a plunger 56. The plunger 56 may have an upper portion 58, a central portion 60 and a lower portion 62. Preferably, the portions 58, 60, 62 are unitary, one piece and integrally formed with one another. The plunger 56 may be made out of a resilient material such as metal, plastic and/or composite materials. In one embodiment, the plunger 56 may be constructed of stamped, machined and/or cast metal, such as steel.

The plunger 56 may have a first side 64, a second side 66, a third side 68 and a fourth side 70. The sides 64, 66, 68 and 70 comprise and define the upper portion 58, the central portion 60 and the lower portion 62. The first 64 and second 66 sides may be planar. The first and second sides 64, 66 may be parallel one another. The third and fourth sides 68, 70 may be parallel one another. The third and fourth sides 68, 70 may also be planar, and they may comprise the thickness of the material. The thickness of the plunger 56 may be constant along the length of the plunger 56. The planes of the first and second sides 64, 66 may be oriented substantially transverse to the planes of the third and fourth sides 68, 70.

The upper portion 58 of the plunger 56 may have a laterally extending finger 72, such as from the third side 68. The finger 72 may extend parallel the planes of the planar first and second sides 64, 66. The finger 72 may have two functions as described below.

A first function of the finger 72 may be to prevent the upper portion 58 the plunger 56 from entirely lowering below the above-mentioned slot 40 in the frame 30. In other words, the finger 72 may contact the frame 30 about the slot 40 to prevent the plunger 56 from moving past the finger 72 into the frame 30.

A second function of the finger 72 may be to function as a portion to grasp so that the plunger 56 can be manually moved selectively upwardly, which is also the longitudinal direction, as will be described in more detail below.

The upper portion 58 may also be provided with a ramp portion 74. The ramp portion 74 may comprise an incline. Preferably, the incline is continuous without gaps or interruptions. The finger 72 may be a continuous extension of the upper portion 58 from the ramp portion 74.

The plunger 56 may be provided with a stop 76 on the lower portion 62. The stop 76 may define a transition 78 from the central portion 60 of the plunger 56 and the lower portion 62 of the plunger 56. The stop 76 may be co-planar with the first and second sides 64, 66. The stop 76 prevents the plunger 56 from overextending and sets the height of the plunger 56 with respect to a locking flange (described below).

As shown in the figures, the stop 76 may extend laterally from the third side 68. The stop 76 may extend at an angle with respect to a longitudinal direction 80 of the plunger 56; the angle may be such as transverse.

The stop 76 may be comprised of two or more surfaces. FIGS. 4-9 depict a first surface 82 and a second surface 84 for the stop 76. The surfaces 82, 84 may be part of the third side 68 of the plunger 56. The first surface 82 may extend laterally transverse to the longitudinal direction 80. The first surface 82 extends to a transition corner 86 where it meets with the second surface 84. The second surface 84 may taper down in the longitudinal direction 80 from the transition corner 86.

The lower portion 62 of the plunger 56 may also have at least one cam way 88. The cam way 88 may be in the shape of an arc that forms a slot in the lower portion 62. In one embodiment, the at least one slotted arc cam way 88 may extend from the first side 64 through the thickness of the plunger 56 to the second side 66. In another embodiment, the at least one slotted arc cam way 88 may only extend partially through the thickness of the plunger 56. In this embodiment, the partial thickness at least one slotted arc cam way 88 comprises a groove in which a cam follower (described below) may follow the groove during motion of the leg 98.

The cam way 88 may have an uppermost portion 90 being closer to the central portion 60 of the plunger 56 compared with a lowermost portion 92 of the cam way 88. The cam way 88 may have one end at approximately a longitudinal axis (noted below) and another end adjacent the fourth side 70.

In one embodiment, the lower portion 62 of the plunger 56 may have two slotted arc cam ways. The slotted arc cam ways may be of unequal length, where the upper cam way 88 has a longer lateral length through the plunger 56 compared with the lower cam way 94.

It is also possible for the lower cam way 94 to just comprise a pivot point, and not be comprised of a cam way 94. As a pivot point, it may be comprised of just an aperture in the plunger 56 without an appreciable lateral length beyond a length sufficient to accommodate a cam follower (described below).

In an embodiment, a biasing member 96 may be located about the plunger 56. As shown in the figures, the biasing member 96 may be such as a coil spring wrapped about at least part of the central portion 60 of the plunger 56. In the depicted embodiment, the stop 76 prevents the biasing member 96 from sliding longitudinally below it. The frame 30 and/or a collar 97 located about the upper portion 58 of the plunger 56 may prevent the biasing member 96 from sliding longitudinally above it.

The locking system 54 may also have at least one leg 98 pivotally attached to the lower portion 62 of the plunger 56. The leg 98 may be comprised of an upper flange 100 and a lower flange 102 with the flanges 100, 102 being connected by a body portion 104. The leg 98 may be integrally formed, unitary and one-piece. The leg 98 may be made out of a resilient material such as metal, plastic and/or composite materials. In one embodiment, the leg 98 may be constructed of stamped, machined and/or cast metal, such as steel.

The leg 98 may have a first side 106, a second side 108, a third side 110 and a fourth side 112. The first and second sides 106, 108 may be planar. The first and second sides 106, 108 may also be parallel one another. The third and fourth sides 110, 112 may be parallel one another. The third and fourth sides 110, 112 may also be planar, but they may comprise the thickness of the material. The thickness of the leg 98 may be constant along the length of the leg 98. The planes of the first and second sides 106, 108 may be oriented substantially transverse the planes of the third and fourth sides 110, 112. As can be appreciated from the foregoing, the plunger 56 may be non-symmetrical about a longitudinal axis 114.

The body portion 104 may have apertures (not shown) therethrough. The apertures accommodate cam followers 116. The cam followers 116 may be such as posts, or mechanical fasteners (such as screws). The cam followers 116 extend into the slotted arc cam ways 88, 94 and selectively follow the cam ways 88, 94.

The upper flange 100 may be located laterally offset from the at least one cam follower 116. The lateral offset may position the upper flange 100 out of alignment with the longitudinal axis 114 of the plunger 56.

The upper flange 100 may be connected to the plunger 56. In one embodiment, the upper flange 100 is connected to the plunger 56 via a biasing member 118. A first end 120 of the biasing member 118 may be connected to an arm 122 of the upper flange 100. The arm 122 may be laterally offset from the longitudinal axis 114 of the plunger 56.

The biasing member 118 may be such as a coil spring. The coil spring may be connected to the plunger 56 at the central portion 60, the lower portion 62 or adjacent the transition 78 of the central portion 60 and the lower portion 62. More particularly, a second end 123 of the biasing member 118 is connected to the plunger 56.

The biasing member 118 may extend at a diagonal from the arm 122 to the plunger 56. In addition, the biasing member 118 may be cross-planar with the fourth side 112 in order to connect between the arm 122 and the plunger 56, as shown in FIG. 11. By cross-planar, it may mean that the biasing member 118 extends at least across the plane of the fourth side 112. In this embodiment, it also may mean that the biasing member 118 extends out of the plane of the fourth side 112 of the leg 98 and into the plane of the fourth side 70 of the plunger 56. The planes of the fourth sides 70, 112 are parallel but not co-planar.

In one embodiment, two legs 98, 124 may be provided. The legs 98, 124 may or may not be the same size or shape. The two legs 98, 124 may both be connected to the plunger 56, such as through the cam followers 116. In other words, the cam followers 116 may connect the first leg 98, extend through the cam ways 88, 94 and connect the second leg 124. Thus, the first and second legs 98, 124 are connected together and may move simultaneously.

Preferably, the two legs 98, 124 have the same or similar lower flange 102 size and shapes. The two legs 98, 124 are mounted to either side of the lower portion 62 of the plunger 56. The two legs 98, 124 may be parallel the first and second sides 64, 66 of the plunger 56. The two legs 98, 124 are not co-planar with one another as they are separated by the plunger 56.

The two legs 98, 124 may differ from one another in that the second leg 124 may not have an upper flange. In one embodiment, the second leg 124 may terminate adjacent the cam follower 116. Additionally, a biasing member does not directly connect the second leg 124 with the plunger 56. Instead, the second leg 124 is biased through the biasing member 118 via its connection to the first leg 98.

The locking system 54 may also have a locking flange 126. The locking flange 126 may be located on the movable drawer 48, such as through mechanical fasteners (not shown). In another embodiment, the locking flange 126 may be unitary, one-piece and integrally formed with the drawer 48. In any case, while the locking flange 126 moves with the drawer 48, the locking flange 126 itself is stationary with respect to the drawer 48.

The locking flange 126 may have an anchor portion 128 and a trip portion 130. The locking flange 126, and thus the anchor and trip portions 128, 130, may be unitary, one-piece and integrally formed. The locking flange 126 may be constructed of a resilient material such as metal, plastic and/or composite materials. In one embodiment, the locking flange 126 may be constructed of stamped, machined and/or cast metal, such as steel.

The trip portion 130 may be located at an angle with respect to the anchor portion 128. The angle may be such as perpendicular. The trip portion 130 may have a longitudinal length that is the same as, or at least a portion of, a longitudinal length of the lower flange 102.

A method of using the locking system 54 may include providing the first moveable member 28 in an initial open position, thus the member 28 is at least partially located out of the frame 30. In this condition, the biasing member 96 has biased the plunger 56 along with the at least one leg 98 in a longitudinally upward position such that the upper portion 58 of the plunger 56 extends through the slot 40 and above the frame 30. It can be appreciated that via their connection, the plunger 56 and the at least one leg 98 travel simultaneously with one another in the longitudinal upward and downward direction. The drawer 48 may be in an open or closed position with the member 28 open.

The member 28 may be substantially located within the frame 30, such as when the member 28 is closed. As the member 28 is moved into the frame 30, the member 28 contacts the ramp portion 74 of the plunger 56. The member 28 moves along the ramp portion 74 and forces the plunger 56, and the at least one leg 98, to move against the biasing member 96 in a longitudinal downward position. When the member 28 is located in contact with the finger 72, the plunger 56 is in its furthest longitudinal downward direction position. The second locker 26 may be in an open or closed position during this step.

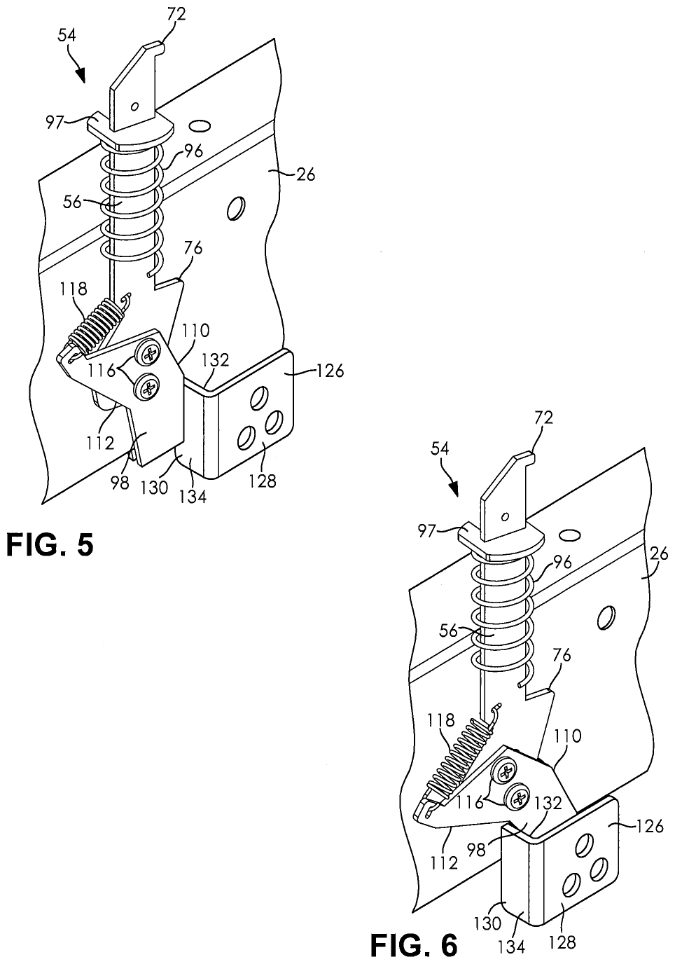

If the second locker 26 is in a closed position when the member 28 is closed, the plunger 56 and the at least one leg 98, when moved in the longitudinally downward direction, together cause the at least one leg 98 to move in the longitudinal alignment with the locking flange 126. More particularly, as may be seen in FIG. 5, the at least one leg 98 moves adjacent a front side 134 of trip portion 130 so that the at least one leg 98 blocks the path of the trip portion 130 if one would try to open the drawer 48. It can further be appreciated that with the at least one leg 98 in this longitudinal position and adjacent the trip portion 130, the at least one leg 98 will not pivot against the trip portion 130 since the cam follower 116 is located against an end in the cam way 88 and/or 94. In other words, the at least one leg 98 will not move in a clockwise direction with respect to the trip portion 130 when the leg 98 is behind the front side 134 of the trip portion 130.

If the second locker 26 is in an open position when the member 28 is closed, the plunger 56 and at least one leg 98 extend longitudinally downward adjacent the second locker 26. The plunger 56 and the at least one leg 98 do not engage with the locking flange 126 until the second locker 26 is closed.

When the second locker 26 is moved into a closed position, the locking flange 126 may travel with the second locker 26. When the locking flange 126 encounters the at least one leg 98, the at least one leg 98 pivots past the trip portion 130 when the fourth side 112 of the at least one leg 98 contacts a rear side 132 of the trip portion 130, as shown in FIGS. 4 and 6. The at least one leg 98 pivots back in a counter-clockwise direction with the at least one cam follower 116 moving within the cam way 88 and/or 94. The pivoting movement of the at least one leg 98 causes the biasing member 118 to stretch. As the second locker 26 is moved further, the at least one leg 98 clears the trip portion 130 and is sprung back into its biased downward location by the biasing member 118, as shown in FIG. 5. The at least one leg 98 is now located in front of the locking flange 126. In this position, the at least one leg 98 locks with the front side 134 of the trip portion 130 when the third side 110 of the at least one leg 98 contacts the front side 134 of the trip portion 130. As mentioned above, the at least one leg 98 blocks the path of the trip portion 130 preventing the drawer 48 from opening.

The second locker 26 can only be opened (or moved away from its closed position) when the member 28 is opened and the plunger 56 and the at least one leg 98 are biased in the longitudinally vertical direction via the biasing force of the spring 96. This action causes the at least one leg 98 to vertically clear the trip portion 130 in the longitudinal direction, thus permitting the drawer to be opened.

Based on the above, when the member 28 is in an open condition, the drawer 48 can be opened and closed without any interference of the locking system 54. This is because the plunger 56 and the at least one leg 98 are located longitudinally above the locking flange 126 via a longitudinal gap 136. Thus, the locking flange 126 can travel in and out of the drawer 48 without contact with the at least one leg 98.

In another embodiment, the biasing member 118 may be replaced with a rubber bushing or other elastic-type member. The elastic-type member may be used to bounce, or otherwise push, the leg 98 back into a downward, longitudinally oriented position after the leg 98 has been rotated by the locking flange 126.

In yet another embodiment depicted in FIG. 12, a biasing member 118 and an elastic-type member may be avoided and gravity may be used to rotate the leg 98 back into a downward, longitudinally oriented positon after the leg 98 has been rotated by the locking flange 126. In this embodiment, the leg 98 is a gravity-biased leg.

While the description and figures depict one locking system 54 used with a compartment 20, it can be readily appreciated that more than one locking system 54 can be used with the compartment 20. By way of example, one locking system 54 can be used on one side of the drawer system 44 and a second locking system 54 can be used on an opposite side of the drawer system 44.

It can also be appreciated that the compartment 20 may comprise additional lockers beyond a first and second locker 24, 26. For example, multiple drawer systems 44 may be provided and connected, or stacked, with one another. One or more locking systems 54 may be elongated and provided through the connected drawer systems so that they can be selectively locked with a first locker 24.

In accordance with the provisions of the patent statutes, the present device has been described in what is considered to represent its preferred embodiments. However, it should be noted that the device can be practiced otherwise than as specifically illustrated and described without departing from its spirit or scope.

What is claimed is:

1. A compartment locking system, comprising:
a plunger having an upper portion, a central portion and a lower portion, said plunger located within a compartment;
at least one leg pivotally attached to said lower portion; and
a first biasing member connecting said plunger with said at least one leg.

2. The compartment locking system of claim 1, wherein said plunger has a first side, a second side, a third side and a fourth side wherein said first and second sides are parallel one another and said third and fourth sides are parallel one another.

3. The compartment locking system of claim 2, wherein said upper portion of said plunger has a finger extending laterally from said third side.

4. The compartment locking system of claim 1, further comprising a second biasing member coiled about said upper portion of said plunger.

5. The compartment locking system of claim 1, wherein said lower portion of said plunger has at least one slotted arc cam way.

6. The compartment locking system of claim 2, wherein a stop extends laterally from said third side of said plunger, said stop separates said central portion from said lower portion.

7. The compartment locking system of claim 2, wherein said first biasing member is connected adjacent the fourth side of said plunger.

8. The compartment locking system of claim 1, wherein said plunger is non-symmetrical about a longitudinal axis.

9. The compartment locking system of claim 5, wherein said at least one leg has at least one cam follower, said cam follower located within said slotted arc cam way.

10. The compartment locking system of claim 8, wherein said at least one leg has an arm laterally offset from the longitudinal axis of the plunger.

11. The compartment locking system of claim 9, wherein said at least one leg has an upper flange located laterally offset from said at least one cam follower, said upper flange being connected to said first biasing member.

12. The compartment locking system of claim 1, wherein said at least one leg comprises a first leg and a second leg wherein said lower portion of said plunger is located between the first leg and the second leg.

13. The compartment locking system of claim 12, wherein said first and second legs have complementary shaped and aligned lower flanges.

14. The compartment locking mechanism of claim 1, further comprising a locking flange having an anchor portion and a trip portion, wherein said trip portion is located at an angle with respect to said anchor portion, wherein said at least one leg pivots past said trip portion when a first side of said at least one leg contacts a first side of said trip portion or said at least one leg locks with a second side of said trip portion when a second side of said at least one leg contacts the second side of the trip portion.

15. A method for using a locking system for a compartment, comprising:
providing a longitudinally movable plunger within said compartment;
pivotally attaching at least one leg to said plunger; and
providing a first biasing member connecting said plunger with said at least one leg.

16. The method of claim 15, further comprising selectively biasing said plunger in a longitudinally raised position with a second biasing member longitudinally aligned with said plunger, wherein both said plunger and said at least one leg longitudinally raise together.

17. The method of claim 16, further comprising selectively locating said plunger in a longitudinally lowered position with a movable member depressing said plunger against said second biasing member, wherein both said plunger and said at least one leg longitudinally lower together.

18. The method of claim 16, wherein when said plunger and at least one leg are longitudinally raised, a longitudinal gap is provided between said at least one leg and a locking flange so that the two do not come in contact in the longitudinal raised position.

19. The method of claim 17, wherein in said lowered position said at least one leg and a locking flange are at least partially longitudinally aligned.

20. The method of claim 19, wherein in said lowered position, in a first direction, said at least one leg pivots past a trip portion of said locking flange when a first side of said at least one leg contacts a first side of said trip portion, and in a second, opposite direction to said first direction, said at least one leg locks with a second side of said trip portion when a second side of said at least one leg contacts the second side of the trip portion.

21. A method for using a locking system for a compartment, comprising:
providing a longitudinally movable plunger;
pivotally attaching at least one gravity-biased leg to said plunger to locate said leg in a longitudinally downward orientation after having been turned away from said longitudinally downward orientation.
